(19) United States
(12) Patent Application Publication
(10) Pub. No.: US 2007/0182152 A1
(43) Pub. Date: Aug. 9, 2007

(54) Structure for foldable post-it-pad paper seat

(75) Inventor: Jour C. T. David, Taipei (TW)

Correspondence Address: TROXELL LAW OFFICE PLLC, SUITE 1404, 5205 LEESBURG PIKE, FALLS CHURCH, VA, 22041, US

(73) Assignee: Kudos Finder Trading Co., Ltd.

(21) Appl. No.: 11/347,176

(22) Filed: Feb. 6, 2006

(51) Int. Cl. B42D 1/00

(52) U.S. Cl. 281/15.1

(57) ABSTRACT

A foldable memo paper seat structure, includes a transparent and hard cover plate and multiple hard boards continuously folded to each other with head and back side. Moreover, on the same spread side, many memo paper sets of different colors are evenly installed, and the two opposite sides of the back side of hard board are installed with touch fastener at appropriate locations for fastening purpose, in order to facilitate the folding and shape forming of hard boards so that they will not separate from each other. In addition, a notch is installed at the same edge of each hard board so that each memo paper set attached and fixed on it can protrude to the outside of the notch. As a result of this design, the user can take single memo paper easily and directly, and the carriage or collection also becomes very easy.

### BACKGROUND OF THE INVENTION

1. Field of the Invention

This invention relates to a structure improvement for a post-it-pad paper seat, it more specifically relates to a folding method to reduce the volume and facilitate carriage and collection, meanwhile, the user can select to partially spread it or to expand it in whole, and any color of post-it-pad paper set can be selected according to the user's favor, single paper consumption each time is possible in order to maximize the longest time of usage.

2. Description of the Prior Art

The use of post-it-pad paper is very popular, it usually comprises of a post-it-pad paper set of specific dimension, the post-it-pad paper set is formed by many post-it-pad paper partially pasted with back glue in one side and folded to one whole body so as to facilitate single sheet use by the user, besides, the back glue of the post-it-pad paper is used to facilitate its attachment to the edge of document folder so as to distinguish and preserve documents of different type, document classification and sorting purpose can thus be achieved.

Most post-it-pad paper seats only contain only one stack of post-it-pad paper set, that is, after the post-it-pad paper set is used up, the post-it-pad paper seat is thrown away due to its uselessness, however, usually the quantity within a stack of post-it-pad paper set is too much, especially it is mostly limited by the structural design of post-it-pad paper seat, this thus leads to the short usage time of both the whole post-it-pad paper set and its paper seat and in turn a waste of resource; furthermore, all the post-it-pad papers of the post-it-pad paper set are of the same color, it is very difficult for classification and distinguishing purpose except adding remarked texts on it, this could lead to trouble and uneasiness to the user; besides, due to long lack of change on the structure and appearance of this type of post-it-pad paper seat, it is not only very stiff but not innovative at all, both the profit and competitive power are reduced.

Due to the drawbacks in the design of the prior art post-it-pad paper seat and its post-it-pad paper set, the inventor of the current invention thus spends great efforts to improve it and finally come out with this “foldable post-it-pad paper seat structure”.

### SUMMARY OF THE INVENTION

The main purpose of the current invention is to provide an extendable post-it-pad paper seat structure which possesses the freedom of favorite color selection, it can be partially spread or expanded in whole during its use, besides, most of the post-it-pad paper sets are of different colors, not only the usage time can be extended, document management, classification, distinguishing and preserving can also be facilitated so that the practical use of the post-it-pad paper seat can be enhanced.

To achieve the above-mentioned goal, the foldable post-it-pad paper seat structure of the current invention comprising of: a cover plate and many hard boards continuously folded to each other with head and back side, moreover, on the same spread side, many post-it-pad paper sets of different colors are evenly installed, and the two opposite sides of the back side of hard board are installed with touch fastener at appropriate locations for fastening purpose, this is to facilitate the folding and shape forming of hard boards so that they won't separate from each other, in addition, a notch is installed at the same edge of each hard board so that each post-it-pad paper set attached and fixed on it can protrude to the outside of the notch; through this way of design, the user can take single post-it-pad paper easily and directly, the carriage or collection also becomes very easy.

The structure, features and functions of the current invention will be explained in the followings accompanied with the attached drawings.

### BRIEF DESCRIPTION OF THE DRAWINGS

FIG. 1 is appearance stereo drawing of a better embodiment of the current invention.

FIG. 2 (A) is planar top view drawing of a better embodiment of the current invention.

FIG. 2 (1) is planar back view drawing of a better embodiment of the current invention.

FIG. 3 is in-usage drawing of a better embodiment of the current invention.

### DETAILED DESCRIPTION OF THE PREFERRED EMBODIMENT

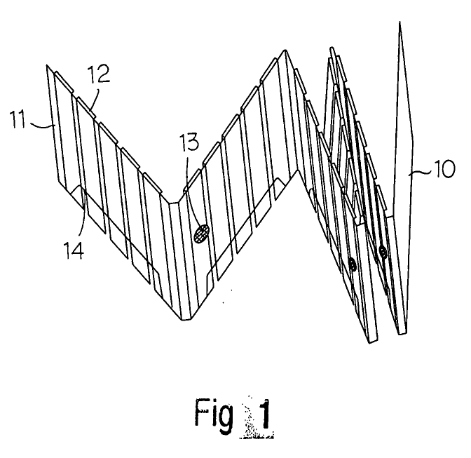

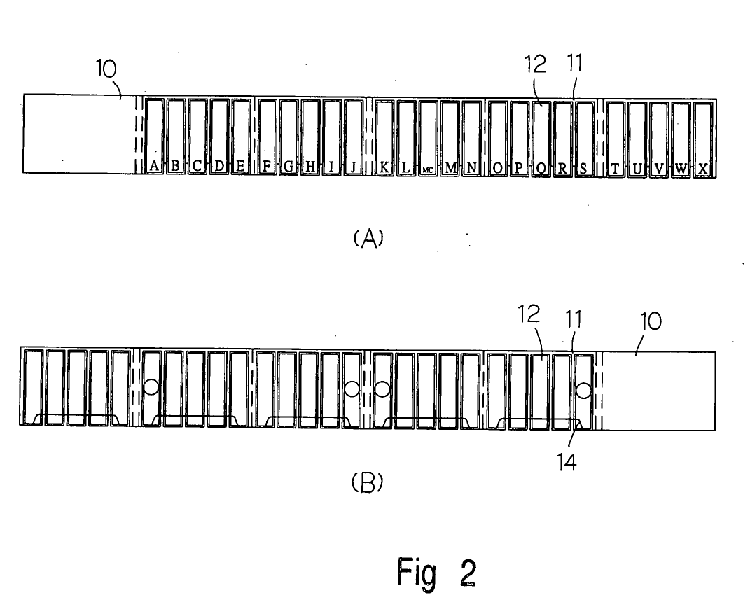

Please refer to FIG. 1, the foldable post-it-pad paper seat structure of the current invention adopts hard material and transparent cover plate (10) and multiple hard boards (11) continuously folded to each other with head and back side; as shown in FIG. 2(A), on the top view of an expansion f foldable post-it-pad paper, we can see that on the same sides of all hard boards (11) are evenly coated with multiple post-it-pad paper sets (12) of the same quantity, further as shown in FIG. 2(B), it is a back side view of an expansion drawing of foldable post-it-pad paper seat, wherein at appropriate location on the back side of each two opposite hard boards (11) are installed with touch fasteners (13) to facilitate the folding and shape forming among multiple hard boards (11) so that they won't separate apart from each other, in addition, on the same side of each hard board (11) is installed with a notch (14) so that all the above-mentioned post-it-pad paper sets (12) attached and fixed onto each hard board (11) can all protrude to the outside of the notch (14) to facilitate the usage of each single sheet.

For the multiple post-it-pad paper sets (12) attached and fixed to each of the above-mentioned hard board (11), each of the post-it-pad paper set (12) is formed by partially pasting and stacking multiple post-it-pad papers, meanwhile, each post-it-pad paper set (12) can be of different color, since cover plate (10) and hard board (11) are all of transparent material, this design thus not only makes the whole foldable post-it-pad paper seat more beautiful in its whole appearance but also enhance the decorative beauty and visional effect of post-it-pad paper seat (1), or simple patterns or text remarks of different colors can be printed on the surface so as to be selected and used by the users, its active and diversified usage method is thus enhanced.

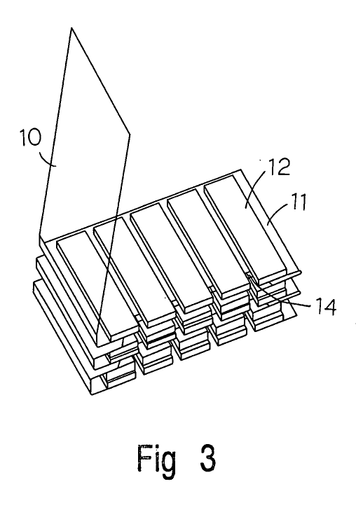

Please refer to FIG. 3 again, according to the above-mentioned foldable post-it-pad paper seat structure, during the actual usage, open cover plate (10) and select appropriate post-it-pad paper sets (12) according to user's need or favor and rip off a single post-it-pad paper sheet for use; similarly, this action is repeated in each usage until all the paper in the post-it-pad paper sets (12) are used up completely.

Since the foldable post-it-pad paper seat of the current invention comprises of multiple hard boards (11) and each expanded hard board (11) is fixed and installed with multiple post-it-pad paper seats (12), therefore, the usage period of the whole post-it-pad paper seat can be extended, this also meets economic efficiency; besides, the user can select needed color and single sheet of post-it-pad paper during its use according to the user's favor, when it is not in use or used, all the hard boards (11) can be folded to each other through head and back sides to facilitate carriage and collection.

To summarize the above, this innovation is really a new and innovative product, and there is no similar innovation or publishing in the similar product, it really meets the application requirement of a new invention, we thus present this application.

However, the above-mentioned is only a better embodiment of the current invention, any equivalent structural change based on the contents of this specification and drawing should all be included in the scope of this invention.

1. A foldable memo paper seat structure, formed by a cover plate and multiple hard boards continuously folded to each other in head and back side, and on the same sides of all the hard boards are evenly installed with multiple memo paper sets of the same quantity, and the two opposite sides of the back side of the hard boards are installed with touch fastener at appropriate locations for fastening purpose, to facilitate the folding and shape forming of the hard boards so that they will not separate from each other.

2. The foldable memo paper seat structure of claim 1 wherein the memo paper sets contain sheets of paper with different colors, or simple patterns of different colors are printed on the surface of the memo paper.

3. The foldable memo paper seat structure of claim 1 wherein one notch is installed at the same edge side of each hard board, and all the memo paper sets attached and fixed on each of the above-mentioned hard board can protrude to the outside of the notch to facilitate a user selecting a single sheet.

4. The foldable memo paper seat structure of claim 1 wherein the cover plate and the hard board are made of transparent materials.
